(19) United States
(12) Patent Application Publication
(10) Pub. No.: US 2025/0260735 A1
(43) Pub. Date: Aug. 14, 2025

(54) CONTAINER IMAGE STREAMING AMONG PEERS IN A DYNAMICALLY SCALABLE P2P CLUSTER

(71) Applicant: Microsoft Technology Licensing, LLC, Redmond, WA (US)

(72) Inventors: Aviral TAKKAR, Bellevue, WA (US); Bin DU, Redmond, WA (US); Sajay ANTONY, Woodinville, WA (US); Qi KE, Parkland, FL (US); Yi Jun LIU, Renton, WA (US); Esteban REY LONDONO, Redmond, WA (US)

(21) Appl. No.: 18/436,883

(22) Filed: Feb. 8, 2024

(51) Int. Cl. H04L 67/1061

(52) U.S. Cl. CPC H04L 67/1065

(57) ABSTRACT

Container images are streamable among peers in a dynamically scalable peer to peer (P2P) cluster. A node receives cluster topography from a dynamically appointed seed node. The node receives an assignment to run a containerized application with a container file system in a container registry as a container process in streaming mode before completing downloading of the container file system. The node discovers a node that has a range of bytes of a file in the container file system, for example, by receiving an advertisement including a key indicating the byte range or by creating and sending a key indicating the byte range in a distributed hash table (DHT). The node provides to the container process the range of bytes of the file received from the discovered node, allowing the container process to run without accessing the container registry for content in the range of bytes of the file.

### BACKGROUND

A container is a standard unit of software that packages up code of an application and all its dependencies, which enables the application to run quickly and reliably from one computing environment to another. A container image (packaged application and dependencies) becomes a container (container process) at runtime. Containers isolate software from its environment and ensure that it works uniformly despite differences between development, staging, and production. Application containerization enables deployment and execution of distributed applications without an entire virtual machine (VM) needing to be launched for each application. Instead, multiple isolated applications or services may run on a single host and access the same operating system kernel.

Peer-to-peer (P2P) networking is a distributed application architecture that partitions tasks or workloads between peers, which may be referred to as “compute nodes” or simply “nodes.” In a P2P network configuration, the peers may be equally privileged network participants that form a peer-to-peer network of nodes. Peers may each make a portion of their resources, such as processing power, disk storage, or network bandwidth, directly available to other P2P network participants, without the need for central coordination by servers or stable hosts. As such, peers in a P2P network are both suppliers and consumers of resources, in contrast to the traditional client-server model in which the consumption and supply of resources are divided. In a P2P network, a static root node may be designated to distribute information about the network to other nodes in the network.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein enable container image (or other content addressable data) streaming among peers in a dynamically scalable peer to peer (P2P) cluster. A node receives a list of nodes in the cluster from another node in the cluster dynamically appointed as a seed node, thereby avoiding single points of failure and manual intervention associated with static seed nodes. The node receives an assignment to run a containerized application with a container file system in a container registry as a container process in streaming mode before completing downloading of the container file system. The node discovers a node in the list of nodes that has a range of bytes of a file in the container file system, for example, by receiving an advertisement including a key indicating the byte range or by creating and sending a key indicating the byte range of content in a distributed hash table (DHT). The node provides to the container process the range of bytes of the file received from the discovered node, allowing the container process to run without accessing the container registry for content in the range of bytes of the file.

As described herein by example, block level image content may be distributed to the runtime of containers. Containers may be executed on Kubernetes hosts using DADI. A P2P architecture may utilize a protocol (e.g., Kademlia) to establish a P2P network in a cluster (e.g., Kubernetes cluster) for the transfer of block level image data on demand during container runtime.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIGS. 1A-1C show block diagrams of portions of example computing systems configured to enable container image streaming among peers in a dynamically scalable P2P cluster, in accordance with embodiments.

FIG. 2 shows a block diagram of an example system configured for streaming container image file blocks between nodes in a P2P cluster with dynamically appointed seed nodes, in accordance with an embodiment.

FIG. 3 shows a flowchart of a process for initializing and streaming container image file blocks between nodes in a P2P cluster with dynamically appointed seed nodes, in accordance with an embodiment.

FIG. 4 shows a flowchart of a process for tracking, requesting, advertising, and streaming content in a dynamically scalable P2P network, in accordance with an embodiment.

FIG. 5A shows a flowchart of a process for initializing, requesting, and streaming container image file blocks between nodes in a P2P cluster with dynamically appointed seed nodes, in accordance with an embodiment.

FIG. 5B shows a flowchart of a process for key-based streaming of content addressable data between nodes in a P2P cluster, in accordance with an embodiment

FIG. 6 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

In a peer to peer (P2P) network, static root nodes are designated to distribute information about the network to nodes in the network. As such, a static root node in a P2P network is a single point of failure. Static root nodes in a P2P network require complex, and time-consuming manual intervention to configure, reconfigure, and replace for changes and failures.

A container image may be composed of multiple incremental layers to enable incremental image distribution. Each layer of a container image may be stored as a binary large object (BLOB) in a container registry. A container registry may be a web service for uploading and downloading container images. Nodes may access a container registry using an application programming interface (API). Each layer of a container image may be a compressed tarball of differences from a previous layer. Containerized applications may be deployed to a P2P cluster. The container image may be downloaded to each node in the cluster where the container is scheduled to run. Downloading a large container image to each node may be the most time-consuming step of starting a containerized application.

Data Acceleration for Disaggregated Infrastructure (DADI) may be implemented as an alternative to a waterfall model of container startup, e.g., downloading entire container image, unpacking the image, and starting the container. DADI may implement a fine-grained, on-demand transfer of remote images. DADI operates with the layering model of a container image and is compatible with a container registry by conforming to Open Container Initiative (OCI) artifacts. DADI models each layer of a container image as a virtual block device (VBD). When a layer is read by the container runtime, DADI translates the file system request for bytes to a range request to a corresponding BLOB in the container registry.

To minimize network I/O to the remote registry, once an image (or parts of it) has been downloaded by a node, other nodes in the cluster can leverage a prior download by a peer to download the content from the peer rather than from the remote container registry. This P2P content streaming can reduce network traffic to the container registry and improve the average download speed per node. A P2P network topology is established in the cluster for P2P content streaming.

DADI P2P data transfer utilizes additional infrastructure to maintain a tree-structured overlay topology. DADI may be implemented in a P2P architecture in large clusters to balance network traffic among participating hosts using statically configured root nodes manually configured with addresses by a cluster operator. The static root nodes serve as a topology manager and interface to the container registry.

The size of an individual layer in a container image may be large (e.g., several gigabytes (GBs)). A bottleneck may be created on a registry if many (e.g., all) nodes in a large cluster try to access the container registry at the same time. This implementation requires cluster operators to maintain root nodes independently of the cluster. Further, this implementation does not scale without manual intervention. Even further, static root nodes are single points of failure.

Embodiments described herein enable container image streaming among peers in a dynamically scalable peer to peer (P2P) cluster. A node receives a list of nodes in the cluster from another node in the cluster dynamically appointed as a seed node, thereby avoiding single points of failure and manual intervention. The node receives an assignment to run a containerized application with a container file system in a container registry as a container process in streaming mode before completing downloading of the container file system. The node discovers a node in the list of nodes that has a range of bytes of a file in the container file system, for example, by receiving an advertisement including a key indicating the byte range or by creating and sending a key indicating the byte range of content in a distributed hash table (DHT). The node provides to the container process the range of bytes of the file received from the discovered node, allowing the container process to run without accessing the container registry for content in the range of bytes of the file.

As described herein by example, block level image content may be distributed to the runtime of containers. Containers may be executed on Kubernetes hosts using DADI. A P2P architecture may utilize a protocol (e.g., Kademlia) to establish a P2P network in a cluster (e.g., Kubernetes cluster) for the transfer of block level image data on demand during container runtime. This approach offers many advantages. For example, cluster operators do not need to maintain root nodes independent of the cluster, the cluster automatically scales to many nodes (e.g., hundreds of thousands of nodes), and the cluster doesn't have any single points of failure, e.g., because the seed nodes are dynamically appointed rather than static. Container performance may be improved for DADI based container runtimes. Further, reliability may be improved and reduce network errors related to container image pulls may be reduced by enabling cluster nodes to stream image file blocks. Further still, the stability of the container registry may be improved, for example, in case of bursty workloads. Even further, the resilience of large cluster deployments may be improved by taking advantage of image content available in a local cluster to create new containers, increasing overall throughput. For example, workloads (e.g., Kubernetes workloads) on clusters with thousands to hundreds of thousands of nodes, such as machine learning (ML) workloads, may run more reliably.

Note that although embodiments are often described herein with respect to container images, it is to be understood that a container image is an example of content addressable data, and that embodiments are applicable to any data that can be accessed from a content addressable store, such as a container registry. As used herein, “content addressable data” is data that is retrievable based on the content of the data (e.g., a hash or other fingerprint) rather than based on its name or location. The content addressable store may be implemented in various ways, including as a Merkle Tree (a tree in which every “leaf” (node) is labelled with the cryptographic hash of a data block, and every node that is not a leaf (a branch, inner node, or inode) is labelled with the cryptographic hash of the labels of its child nodes).

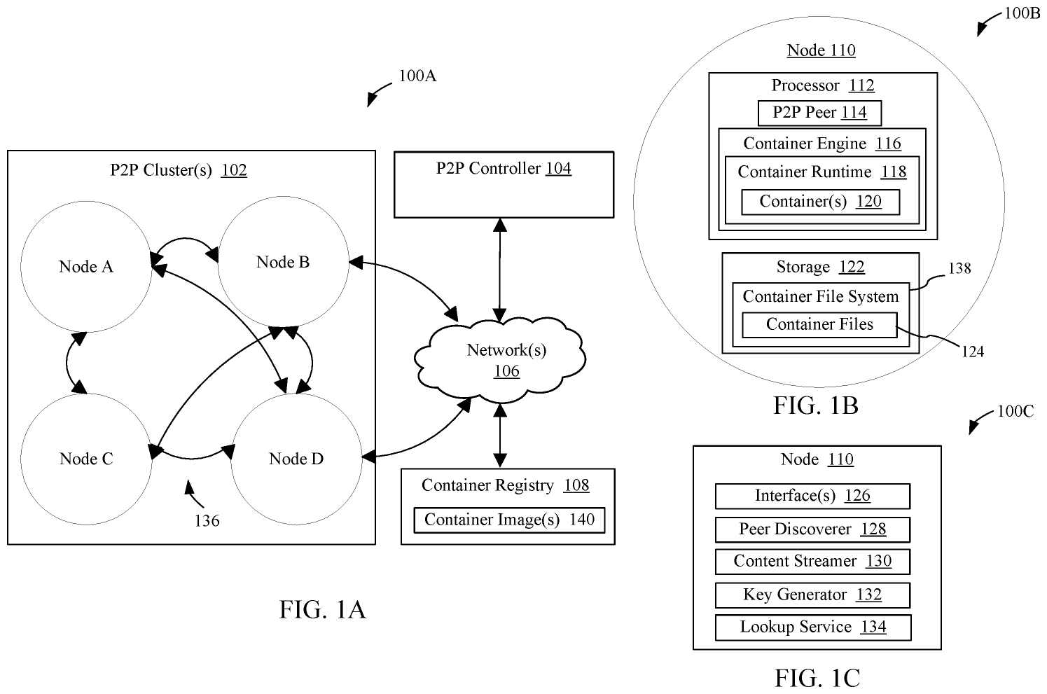

To help illustrate the aforementioned systems and methods, FIGS. 1A-1C are described as follows. In particular, FIGS. 1A-1C show block diagrams of portions of example computing systems 100A-100C (“system 100” hereinafter) configured to enable container image streaming among peers in a dynamically scalable P2P cluster, in accordance with an embodiment. In FIG. 1A, system 100A includes one or more P2P clusters 102, a P2P controller 104, and a container registry 108 communicatively coupled by one or more networks 106. P2P cluster(s) 102 includes nodes A-D interconnected in a P2P network 136, although various implementations of a P2P network may have any number and type of nodes. Container registry 108 includes one or more container images 140. in FIG. 1B, system 100B includes a node 110, which includes a processor 112 and storage 122. Processor 112 includes a P2P peer 114 and a container engine 116, which includes a container runtime 118 that includes one or more containers 120. Container(s) 120 are also referred to herein as container processes. Storage 122 stores container files 124 in a container file system 138. In FIG. 1C, system 100C includes node 110, which includes one or more interfaces 126, a peer discoverer 128, a content streamer 130, a key generator 132, and a lookup service 134. These features of FIGS. 1A-1C are described in further detail as follows.

FIG. 1A shows nodes A-D streaming content (e.g., byte ranges of files associated with the container(s)) from other nodes and from container registry 108. FIG. 1B shows an example of a node among nodes A-D. FIG. 1C shows an example of a portion of P2P peer operation during execution of container(s).

P2P cluster(s) 102 represents one or more clusters in a P2P network 136. P2P network 136 is a type of computer network providing a distributed execution environment for applications, such as containerized applications. P2P cluster(s) 102 includes one or more computing devices comprising node(s) that share resources and services. Each node operates as a client and a server, directly communicating with other computing devices in P2P network 136.

Each node A, B, C, D in P2P cluster(s) 102 represents a peer in P2P cluster(s) 102. Each node may be a virtual or physical machine (e.g., computing device) with a network interface for network communication. Each node may be a single computer or a cluster of computers, which can support one or more transport connections.

A node may include a client application installed on a computing device. Each node may be managed by a control plane (e.g., P2P controller 104). A node may include services necessary to run containers. For example, each node may comprise a computing device configured as a node in a cluster of nodes 102 connected in a dynamically scalable P2P network.

A node may receive an assignment and a configuration, for example, from P2P controller 104. A node may be assigned one or more containerized applications to run as containers. Containers may be instantiated and executed based on container images stored in container registry 108. A container may be associated with a container file system.

A node may be configured to operate in streaming mode, e.g., to execute container(s) prior to downloading all files associated with the container(s), downloading portions (e.g., blocks, chunks, byte ranges) of files as needed to continue execution of the container(s). Nodes may be configured to transfer block level container image data on demand during container runtime. A node may be configured, for example, to stream one or more container images in blocks or chunks representing byte ranges of a file in a container file system. A node may run a container while streaming blocks as needed to continue running the container before completing downloading of the container file system. For example, each node may be configured to provide to the container/process the range of bytes of the file received from the discovered node, allowing the container process to run without accessing the container registry 108 for content in the range of bytes of the file.

A node may be configured to participate in dynamically selecting a seed node (e.g., a root or leader node) that acquires and maintains P2P network topology. Each node may be configured to initially contact upon startup/boot and/or to otherwise (e.g., periodically) contact a dynamically appointed seed node for network topology information (e.g., list of peers) and/or to announce (e.g., advertise) their presence on the P2P network. For example, each node may be configured to receive a list of nodes in the cluster from a node in the cluster dynamically appointed as a seed node.

A node may be configured to first try to stream (e.g., obtain) blocks from peers, e.g., before attempting to stream blocks from container registry 108. For example, each node may be configured to discover a node in the list of nodes that has a range of bytes of a file in the container file system. The discovering of the node in the list of nodes that has the range of bytes of the file in the container file system may comprise receiving an advertisement from another node indicating that the node indicated/discovered in the advertisement has the range of bytes of the file.

A node may be configured to maintain a distributed data structure to discover one or more nodes that has the range of bytes of the file needed to continue execution of the container(s). In some implementations, the data structure may include a distributed hash table (DHT).

A node may be configured (e.g., to implement a protocol) to make a request for content by creating a key and distributing the key to at least one node in the list of nodes that may have the content (e.g., a range of bytes of a file in the container file system). The key may indicate the byte range of the file. The content may be addressable in a data structure (e.g., DHT) maintained by the node using the key provided in the request. A node may be configured to select a node to connect to for content based on a determination that the selected node has the highest probability of storing the range of bytes of the file.

A node may be configured (e.g., to implement a protocol) to push information to other nodes, for example, by advertising to other nodes that the node has content (e.g., a range of bytes of a file) available for streaming.

P2P controller 104 represents a control plane configured to support execution of workloads by containerized applications executed by the P2P network cluster(s) 102. P2P controller 102 may include, for example, an application programming interface (API) server(s), workload scheduler(s), a controller manager, etc. P2P controller 104 may be implemented, for example, by a cloud service provider.

Network(s) 106 may comprise one or more networks such as local area networks (LANs), wide area networks (WANs), enterprise networks, the Internet, etc., and may include one or more of wired and/or wireless portions. Each of cluster(s) 102, controller 104, and registry 108 are communicatively coupled to each other via network(s) 106.

Container registry 108 stores and provides access to (e.g., distribution of) one or more container images 140. Containerization of applications is an operating system (OS)-level virtualization that bundles application code with all dependencies, such as libraries, configuration files, etc., into an executable for execution by processor 112. A node runs a containerized application in an isolated package of code called a container (e.g., container(s) 120 shown in FIG. 1B).

Container image(s) 140 include a collection of content addressable files that represent a container (e.g., container(s) 120). Each file in container image(s) 140 may be identified (e.g., uniquely) by its content and a manifest, which references (e.g., all) content identifiers for the image. Container image(s) 140 may be self-contained, executable package(s). A container image is a template (and contains application, software libraries, etc.) by which a container (e.g., container(s) 120) is realized at runtime. Container(s) 120 are isolated instance(s) of container image(s) 140, running as distinct process(es) on processor 112. Container image(s) 140 may be read-only templates including instructions for creating a container (e.g., container(s) 120). Container image(s) 140 may be static file(s) with executable code (machine instructions) that can create or build container(s) 120 on one or more computing systems (e.g., P2P cluster node A, node B, node C, and/or node D). Container image(s) 140 may be deployed in multiple environments.

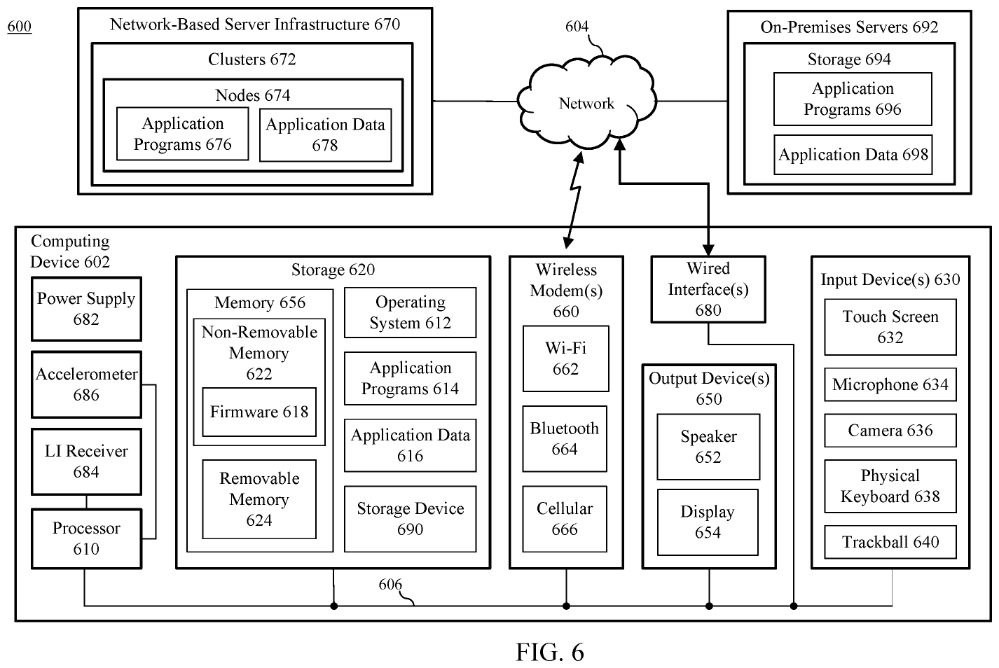

As shown in FIG. 1B, node 110 shows an example of nodes A, B, C, D in FIG. 1A. Node 110 includes computing resources, such as, but not limited to, processor 112 and storage 122. FIG. 6 shows an example of computing resources for nodes A-D.

Processor 112 is configured to execute machine-executable instructions for node 110 to function as a peer in P2P network 136 while streaming blocks of files associated with container(s) 120 from other peers (e.g., and/or container registry 108) as needed and providing the blocks to container(s) 120 to continue running before complete download of all files associated with the container(s) 120. Processor 112 may execute code implementing a P2P peer 114, causing node 110 to operate as a node in P2P cluster 102. Processor 112 may execute code implementing a container engine 116 and a container runtime 118. Container(s) 120 may be executed in an environment generated by execution of container engine 118 and container runtime 120. An example of processor 112 is shown and described as processor 610 in FIG. 6.

Storage 122 stores container files 124 (stored based on a container file system 138) and/or portions thereof (e.g., content blocks), which may have been originally obtained (e.g., by one node or another) from container registry 108. Storage 122 may store a data structure, such as a DHT, indicating storage addresses for content blocks. Content blocks may be addressable, for example, by keys indicating byte ranges of container files. An example of storage 122 is shown and described as storage 620 in FIG. 6.

Container files 124 may be stored based on a container file system 138. Container file system 138 is a structure used by an operating system (OS) to name, organize and manage container files on a storage device. Such a file system defines how data is stored, accessed, and organized on the storage device. Different file systems have different characteristics that may be specific to operating systems or devices. Examples of file systems include: FAT (File Allocation Table), FAT16, FAT32, Extended File Allocation Table (exFAT), New Technology File System (NTFS), union file system (UFS, such as OverlayFS), etc.

Applications, such as containerized applications represented by container image(s) 140, may be executed in a networked environment, such as a P2P network, e.g., as described herein.

P2P peer 114 may be a client application installed on and executed by a computing device (e.g., computing device 602). Execution of P2P peer 114 by processor 112 results in operation a computing device as peer node 110 in P2P cluster 102. Node 110, as a peer/node in P2P cluster 102, may perform peer discovery and peer routing operations, as indicated by arrows between nodes in FIG. 1A.

Peer discovery involves finding other nodes in P2P network 136. Peer discovery may be active or passive. Active peer discovery involves sending queries or requests to one or more peers, which may include dynamically appointed seed nodes. Nodes may maintain lookup services to provide information and/or content, e.g., using DHTs. Passive peer discovery involves listening for or broadcasting messages on the P2P network, for example, using a gossip protocol.

Peer routing involves selecting nodes and delivering messages to one or more nodes in the P2P network. Peer routing may be structured or unstructured. Structured peer routing may involve organizing a P2P network into a logical organization and assigning each node a unique identifier or address. Messages may be routed based on the logical organization and unique identifier or address, for example, using an algorithm (e.g., Kademlia). Unstructured peer routing may involve routing messages to random or nearby nodes, for example, based on proximity routing.

Container engine 116 is software (e.g., computer-executable instructions) that processes requests, such as command line instructions. Container engine 116 can run multiple, isolated, instances of container(s) 120, on the same operating system (OS) kernel (not shown), which translates software commands into machine language instructions understood by the underlying computing device processor 112. Container(s) 120 perform virtualization at the OS level, rendering them independent of OS, but dependent on container engine 116, for implementation. Examples of container engine 116 include Kubernetes and Docker. Kubernetes can use different container runtimes as container runtime 118. For example, Kubernetes may support container runtimes including Docker, containerd, CRI-O, and Kubernetes Container Runtime Interface (CRI), etc.

Container engine 116 may interact with the container runtime 118 to create and manage containers. Container runtime 118 may be a component of container engine 116. Container runtime may communicate with the OS kernel for containerization and configuration of access and security policies to run container(s) 120.

Container engine 116 may be used to manage container image(s) 140 and container(s) 120. Container engine may download (e.g., stream) content (e.g., byte ranges of files) in container image(s) 140 from other nodes (e.g., Node A, B, C, D) and/or container registry 108. Container runtime 118 may perform low-level management of container(s) 120 and container image(s) 140 for container engine 116.

Container engine 116 may operate as a client-server application with a daemon process that manages interactions with the OS kernel. Container engine 116 may include interfaces (e.g., application programming interfaces (APIs)) that can be used by container(s) 120 to communicate with the daemon process. The daemon may create and manage objects, such as container image(s) 140, container(s) 120, network(s) 106, and storage 122 volumes.

Container runtime 118 may be a subcomponent of container engine 116. Runtime is when a program is running, e.g., when the machine (e.g., processor 112) executes the program's code as machine code. Container runtime 118 may manage the execution and lifecycle of container(s) 120. Container runtime 118 may manage container image 140 block transfer (e.g., streaming) and storage from nodes A, B, C, S, and/or container registry 108, execution and supervision of container(s) 120, storage 122, etc.

Container(s) 120 are self-contained, executable application(s) and/or service(s). Container(s) 120 represent one or more process(es). Container(s) 120 are realized instances of container image(s) 140 being executed on a host system (e.g., node 110). A container instance deployed to one or more nodes may be referred to as a workload. Each container 120 may include one or more processes and services running in parallel in an isolated environment. Container(s) 120 are a packages of code including dependencies allowing the containerized application to run on multiple computing environments. Container(s) 120 provide isolation, allowing multiple containers to run on node 110 without conflicts. Container(s) 120 may engage in container networking, e.g., to communicate with other containers.

As shown in FIG. 1C, node 110 may include one or more components configured to perform one or more functions/operations in P2P cluster 102, which may include applying one or more protocols. For example, node 110 may include interface(s) 126, peer discoverer 128, content streamer 130, key generator 132, and lookup service 134.

Interface(s) 126 may include one or more APIs that may be used to interact with node 110 and/or container(s) 120. For example, interface(s) 126 may include a network interface that other peers/nodes may use to communicate with node 110.

Peer discoverer 128 may be configured to initially, periodically, continuously, or otherwise discover and maintain information about other P2P network nodes, such as their location, proximity, container file blocks they have, etc. For example, peer discoverer 128 may contact a dynamically selected seed node upon initialization/boot to obtain an initial list of peers to begin building and maintaining P2P network topology for purposes of requesting and providing information, including streaming blocks to run container(s) 120. For example, peer discoverer 128 may be configured to receive a list of nodes in the cluster from a node in the cluster dynamically appointed as a seed node.

Content streamer 130 may generate requests and responses to stream block content to node 110 from other nodes and container registry 108 or from node 110 to other nodes. For example, content streamer 130 may be configured to provide to the container(s) 120 streamed block content (e.g., range of bytes of a file) received from a discovered node or container registry with the content, allowing the container(s) 120 to continue running prior to complete downloading of all files in container image(s) 140. Content streamer 130 may be configured to advertise block content that node 110 has available for streaming to other nodes. For example, content streamer 130 may be configured to use a distributed data structure (e.g., DHT) to discover the node that has content (e.g., a range of bytes of a file) needed by node 110 to continue running container(s) 120. For example, content streamer 130 may be configured to distribute a key generated by key generator 132 to at least one node among known nodes provided by peer discoverer 128 or lookup service 134 to make a request to stream the content. Content streamer 130 may be configured to send and receive advertisements about which nodes have what content, which may be based on information in lookup service 134 or may be used to update information in lookup service 134. Content streamer 130 may select a node to connect to for content based on a determination that the selected node has the highest probability of storing content, e.g., based on information obtained from lookup service 134.

Key generator 132 may be configured to generate keys for streamable block content. The key may indicate the byte range of a file. The keys may be provided to content streamer 130 and/or lookup service 134.

Lookup service 134 may create and maintain a lookup service for node 110 and other nodes, including block content they may have. Lookup service 134 may be responsive to lookups requested by peer discoverer 128 and/or content streamer 130. Lookup service 134 may create and maintain information in a data structure, such as a DHT with content addressable memory. Lookup service may lookup information (e.g., in the DHT), for example, using keys generated by key generator 132 and/or keys generated by other nodes. Content (e.g., range of bytes of a file) may be addressable in the DHT using a key indicating the content (e.g., range of bytes of a file). For example, lookup service 134 may be configured to discover a node in the list of nodes that has a range of bytes of a file in the container file system.

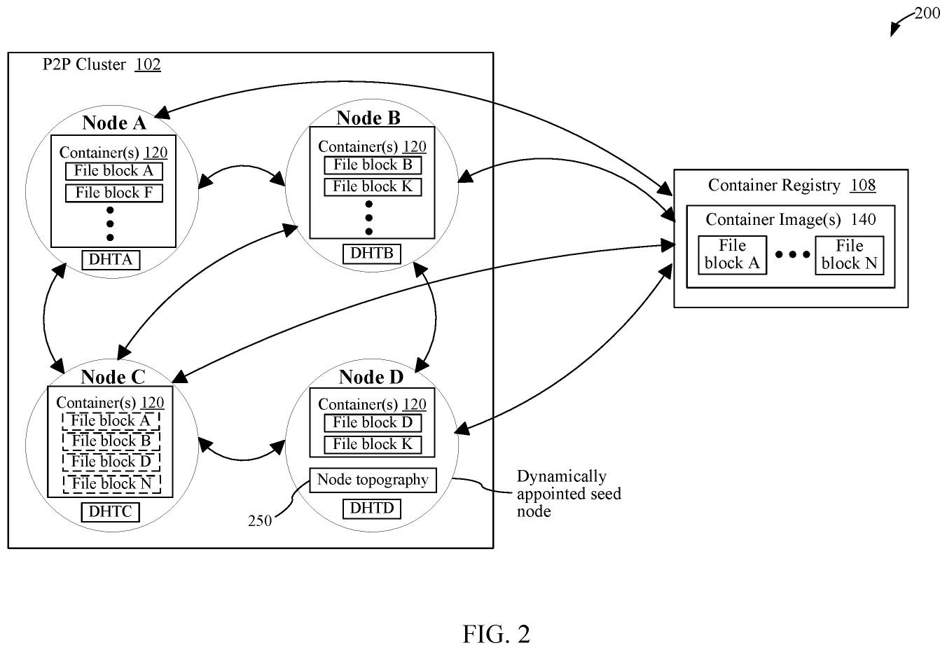

FIG. 2 shows a block diagram of an example system 200 of streaming container image file blocks between nodes in a P2P cluster with dynamically appointed seed nodes, in accordance with an embodiment. FIG. 2 shows an example of nodes A, B, C, and D in P2P cluster 102 engaged in P2P streaming of file blocks to run container(s) 120 prior to downloading entire container image(s) 140 from container registry 108. As shown in FIG. 2, nodes A, B, C, and D participated in dynamically selecting node D as a seed node to maintain node topography 250. Upon initialization, periodically, and/or otherwise, nodes A, B, and C, obtain dynamically changeable node topography for P2P cluster 102 from node D.

As shown in FIG. 2, each node A, B, C, and D has a different state of downloading container image(s) 140, e.g., with a different set of file blocks. Each node A, B, C, and D maintains a respective data structure (e.g., DHT) to track file blocks in a lookup service, e.g., based on keys indicating byte ranges of container image files (indicated as file blocks). For example, node A maintains DHTA, node B maintains DHTB, node C maintains DHTC, and node D maintains DHTD. The combination of distributed hash tables DHTA, DHTB, DHTC, and DHTD provide a composite hash table.

As shown in FIG. 2, node A may have streamed file blocks A and F from container registry 108. Node B may have streamed file blocks B and K from container registry 108. Node D may have streamed file block D from container registry and file block K from node B. Nodes A, B, and/or D may advertise that they have file blocks A, B, and D, which node C may use to request file blocks A, B, and D as needed while running container(s) 120. Node C may generate a key for each file block A, B, and D and send the keys in requests to nodes A, B, and D. Node A may perform a lookup of file block A in DHTA using the key indicating a byte range of file block A received from node C. Node B may perform a lookup of file block B in DHTA using the key indicating a byte range of file block B received from node C. Node D may perform a lookup of file block D in DHTA using the key indicating a byte range of file block D received from node C. Node C may receive responses from nodes A, B, and D, which may include the requested file blocks. For example, node A may stream file block A to node C, node B may stream file block B to node C, node D may stream file block D to node C. Having received file block N, container registry 108 may stream file block N to node C.

In some examples, a protocol (e.g., libp2p, Kademlia) may be implemented for a dynamic P2P network including P2P cluster(s) 102 where many nodes (e.g., millions of nodes), including nodes A, B, C, and D, dynamically connect and disconnect with each other, dynamically select seed nodes among themselves (e.g., without statically configured root nodes), and stream block level container image content (e.g., using DADI). A distributed hash table protocol, such as Kademlia, enables peers to discover and read content (e.g., byte ranges of file BLOBs) from another peer in P2P cluster 102 without a need for third node (e.g., static root node) to orchestrate the flow of data in P2P cluster 102.

A node that is initializing lacks preconfigured information about the topology of the network, and lacks configuration about where to bootstrap its network configuration from. A dynamic leader election protocol (e.g., Kubernetes) may be used to dynamically elect seed (e.g., leader, root) nodes, such as node D. For example, nodes A, B, C, and D may dynamically select node D as a bootstrap for nodes in P2P cluster 102 to connect to, e.g., in order to bootstrap a P2P network configuration. Dynamic selection of bootstrap nodes in conjunction with block content streaming allows a P2P cluster 102 to scale operation to any number of nodes without single points of failure in static nodes and without bottlenecks at container registry 108.

A node (e.g., node A, B, C, or D) attempting to read block content (e.g., a range of bytes) of a layer in container image 140 may create a content identifier based on the layer content and the offset it's trying to read from. As described herein, the identifier may be a key. The layer content may be uniquely identified, for example, by a hash (e.g., SHA256 digest) of the layer content. The read offset may be used to calculate a chunk number. A chunk (block) may be a fixed size block of the layer. The content identifier may be created, for example, by appending the chunk number to the layer digest. A node may employ a lookup service using a data structure (e.g., a DHT) to dynamically look up peers that may have already downloaded the block of content. The node may download the content from a peer (node) found to have the content, e.g., peer-to-peer content streaming. The node may download the content from the container registry 108 if a node with the content is not discovered.

A node may advertise downloaded/streamed content as available for download/streaming by other nodes in the P2P the network, for example, by updating its local data structure (e.g., DHT) for its lookup service and broadcasting the available content. Other nodes may message requests, for example, using a key that a node's lookup service uses to read and send content.

A protocol (e.g., Kademlia protocol) may be used to advertise, look up, and stream among peers block content (e.g., chunks) of a (e.g., DADI) container image layer, establishing a peer-to-peer network for dynamic data streaming without additional burdens on cluster operations. Cluster operators do not need to maintain dedicated static root nodes for P2P streaming operations. A binary may be installed on each node (e.g., nodes A, B, C, and D) to implement a proxy. Installation of the binary on each node may be automated. Nodes may use, for example, a libp2p library. This allows scaling to many nodes (e.g., thousands to hundreds of thousands of nodes) without a single point of failure, such as DADI using dedicated (static) DADI root nodes to distribute data in the network.

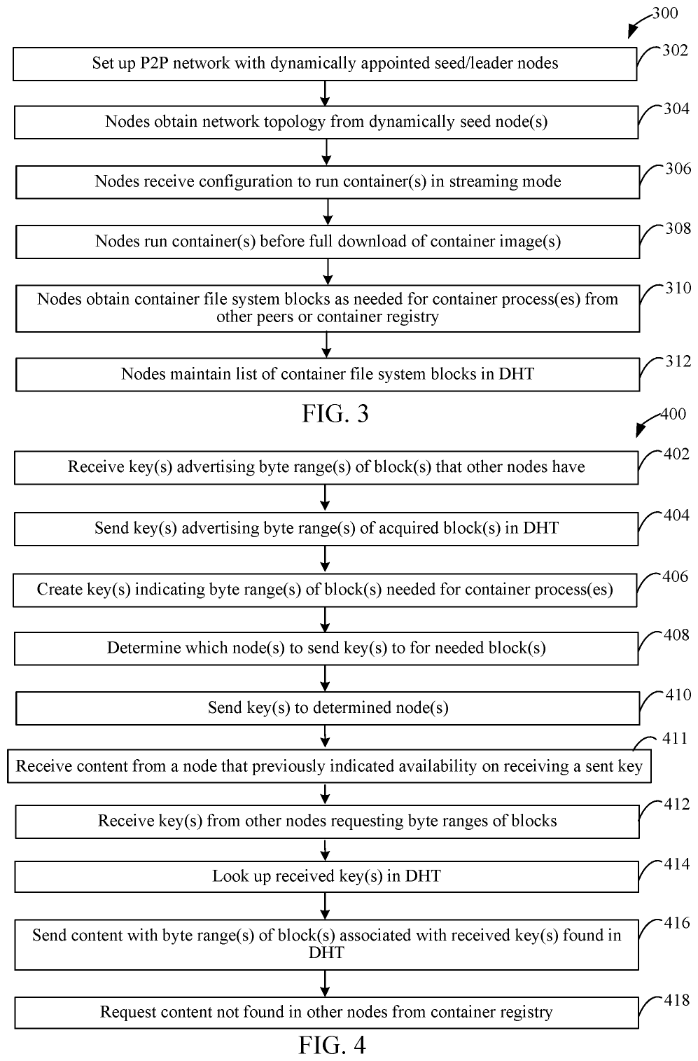

For illustrative purposes, further example structure and operation of nodes A, B, C, and D in P2P cluster(s) 102 and container registry 108 shown in FIGS. 1A-1C and FIG. 2 are described below with respect to FIG. 3. FIG. 3 shows a flowchart 300 of a process for initializing and streaming container image file blocks between nodes in a P2P cluster with dynamically appointed seed nodes, in accordance with an embodiment. Nodes A, B, C, and D in P2P cluster(s) 102 and container registry 108 may operate according to flowchart 300 in embodiments. Note that not all steps of flowchart 300 need be performed in all embodiments. Further structural and operational embodiments will be apparent to persons skilled in the relevant art(s) based on the following description of FIG. 3.

Flowchart 300 begins with step 302. In step 302, a P2P network may be set up (e.g., initialized) with dynamically appointed seed/leader nodes. For example, as shown in FIGS. 1A-1C and FIG. 2, P2P cluster 102 may be set up by P2P controller 104. Nodes A, B, C, and D may dynamically appoint node D as a seed/leader node to create and maintain node topography 250 for reference by other nodes. Each node may run a leader election when joining P2P cluster 102, so that they discover an existing seed node or elect a new seed node.

In step 304, nodes may obtain network topology from dynamically seed node(s). For example, as shown in FIGS. 1A-1C and FIG. 2, nodes A, B, and C may obtain network topology from node D, which is a dynamically selected seed node. Node D, as the dynamically appointed seed node, may accumulate and share information, such as cluster topology, nodes in the cluster, public keys of nodes for secure connections, which nodes are part of P2P cluster 102 and how nodes can reach them for communication, etc.

In step 306, nodes may receive a configuration to run container(s) in streaming mode. For example, as shown in FIGS. 1A-1C and FIG. 2, P2P controller 104 may provide a configuration to nodes A, B, C, and D to run container(s) 120 in streaming mode.

In step 308, nodes may run container(s) before full download of container image(s). For example, as shown in FIGS. 1A-1C and FIG. 2, nodes A, B, C, and D to run container(s) 120 before full download of container image(s) 140.

In step 310, nodes may obtain container file system blocks as needed for container process(es) from other peers or container registry. For example, as shown in FIGS. 1A-1C and FIG. 2, node C streams file block A from node A, file block B from node B, and file block D from node D, and node D streams file block K from node B.

In step 312, nodes maintain a list of container file system blocks in DHT. For example, as shown in FIGS. 1A-1C and FIG. 2, node A maintains a list of container file system blocks in DHTA for a lookup service, node B maintains a list of container file system blocks in DHTB for a lookup service, node C maintains a list of container file system blocks in DHTC for a lookup service, and node D maintains a list of container file system blocks in DHTD for a lookup service.

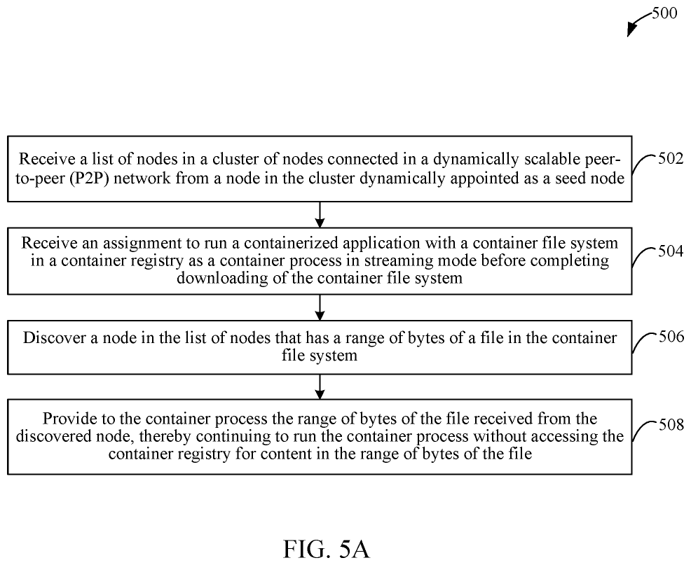

For illustrative purposes, further example structure and operation of nodes A, B, C, and D in P2P cluster(s) 102 and container registry 108 shown in FIGS. 1A-1C and FIG. 2 are described below with respect to FIG. 4. FIG. 4 shows a flowchart 400 of a process for tracking, requesting, advertising, and streaming content in a dynamically scalable P2P network, in accordance with an embodiment. Nodes A, B, C, and D in P2P cluster(s) 102 and container registry 108 may operate according to flowchart 400 in embodiments. Note that not all steps of flowchart 400 need be performed in all embodiments. Further structural and operational embodiments will be apparent to persons skilled in the relevant art(s) based on the following description of FIG. 4.

Flowchart 400 begins with step 402. In step 402, key(s) may be received that advertise byte range(s) of block(s) that other nodes have. For example, as shown in FIGS. 1A-1C and FIG. 2, node C may receive an advertisement of file blocks A and/or F from node A, an advertisement of file blocks B and/or K from node B, and/or an advertisement of file block D from node D.

In step 404, key(s) may be sent to advertise byte range(s) of acquired block(s) in DHT. For example, as shown in FIGS. 1A-1C and FIG. 2, node C may send an advertisement to nodes A, B, and/or D indicating that node C has file block A, B, D, and/or N available for streaming.

In step 406, key(s) may be created that indicate byte range(s) of block(s) needed for container process(es). For example, as shown in FIGS. 1A-1C and FIG. 2, node C may create keys for file blocks A, B, D, and N indicating their byte range(s) for streaming so that Node C container(s) 120 can continue running.

In step 408, a determination may be made about which node(s) to send key(s) to for needed block(s). For example, as shown in FIGS. 1A-1C and FIG. 2, node C may consult its lookup service, which uses DHTC to determine whether and which nodes have file blocks A, B, D, and N.

In step 410, key(s) may be sent to determined node(s). For example, as shown in FIGS. 1A-1C and FIG. 2, node C may send the key indicating the byte range(s) for file block A to node A, the key indicating the byte range(s) for file block B to node B, and the key indicating the byte range(s) for file block D to node D based on node C's lookup service determining those nodes have the relevant file blocks.

In step 411, content is received from a node that previously indicated availability on receiving a sent key. For example, as shown in FIGS. 1A-1C and FIG. 2, node C may receive content from node A in response to node A previously indicating availability on receiving the sent key. Note that in an embodiment, node A may not store the key received from node C and may respond with an indication of having the content or an indication that the content is not available, in response to C making the request.

In step 412, key(s) may be received from other nodes requesting byte ranges of blocks. For example, as shown in FIGS. 1A-1C and FIG. 2, node C may receive a key from node A requesting the byte range(s) for file blocks B, D, and/or N.

In step 414, received key(s) may be looked up in DHT. For example, as shown in FIGS. 1A-1C and FIG. 2, node C may use its lookup service with reference to DHTC to find requested file blocks B, D, and/or N to requesting node A.

In step 416, content may be sent with byte range(s) of block(s) associated with received key(s) found in DHT. For example, as shown in FIGS. 1A-1C and FIG. 2, node C may use the determined locations of file blocks B, D, and/or N to access and send requested file blocks B, D, and/or N to requesting node A.

In step 418, content not found in other nodes may be requested from the container registry. For example, as shown in FIGS. 1A-1C and FIG. 2, node C may stream file block N from container registry 108, after node C's lookup service failed to find any node with file block N in DHTC.

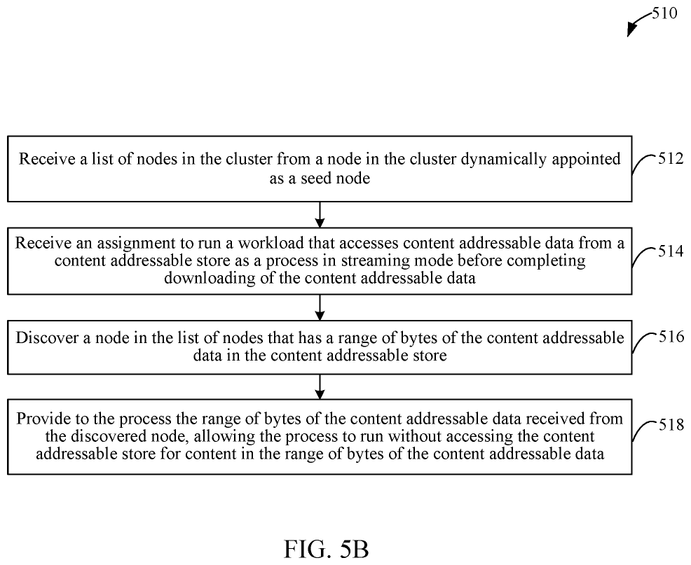

For illustrative purposes, further example structure and operation of nodes A, B, C, and D in P2P cluster(s) 102 and container registry 108 shown in FIGS. 1A-1C and FIG. 2 are described below with respect to FIG. 5A. FIG. 5A shows a flowchart 500 of a process for key-based streaming of container image file blocks between nodes in a P2P cluster with dynamically appointed seed nodes, in accordance with an embodiment. Nodes A, B, C, and D in P2P cluster(s) 102 and container registry 108 may operate according to flowchart 500 in embodiments. Note that not all steps of flowchart 500 need be performed in all embodiments. Further structural and operational embodiments will be apparent to persons skilled in the relevant art(s) based on the following description of FIG. 5A.

Flowchart 500 begins with step 502. In step 502, a list of nodes in a cluster of nodes connected in a dynamically scalable peer-to-peer (P2P) network may be received from a node in the cluster dynamically appointed as a seed node. For example, as shown in FIGS. 1A-1C and FIG. 2, node C (e.g., upon initialization) may receive a list of nodes in P2P cluster 102 from node D, which is a dynamically appointed seed node.

In step 504, an assignment may be received to run a containerized application with a container file system in a container registry as a container process in streaming mode before completing downloading of the container file system. For example, as shown in FIGS. 1A-1C and FIG. 2, P2P controller 104 may provide a configuration to nodes A, B, C, and D to run container(s) 120 in streaming mode.

In step 506, a node may be discovered in the list of nodes that has a range of bytes of a file in the container file system. For example, as shown in FIGS. 1A-1C and FIG. 2, node C may consult its lookup service, which uses the list of nodes in P2P cluster 102 obtained from dynamically appointed seed node D and the data structure DHTC to determine whether and which nodes have file blocks A, B, D, and N needed to continue running container(s) 120.

In step 508, the range of bytes of the file received from the discovered node may be provided to the container process, allowing the container process to run without accessing the container registry for content in the range of bytes of the file. For example, as shown in FIGS. 1A-1C and FIG. 2, node C may provide file blocks A, B, and/or D received from nodes A, B, and D to container(s) 120 without accessing container registry 108.

As noted above, a container image is an example of content addressable data, and embodiments are applicable to any data that can be accessed from a content addressable store, of which a container registry is an example. In one example, a content addressable data storage system may function to store a file by passing the content of the file through a cryptographic hash function to generate a unique key, which becomes the content address. The file system directory stores these addresses and a pointer to the physical storage of the content. Because an attempt to store the same file generates the same key, a content addressable data storage system ensures that the files stored within are unique. Because the changing of the file results in a new key being determined, assurance is provided that the file is unchanged.

In embodiments, flowchart 500 of FIG. 5A, which relates to container embodiments, may also be applied to other forms of content addressable data.

For instance, FIG. 5B shows a flowchart 510 of a process for key-based streaming of content addressable data between nodes in a P2P cluster, in accordance with an embodiment. Nodes A, B, C, and D in P2P cluster(s) 102 and container registry 108 may operate according to flowchart 510 in embodiments. Further note that in the embodiment of flowchart 510, another type of content addressable store may be used in place of container registry 108. Note that not all steps of flowchart 510 need be performed in all embodiments. Further structural and operational embodiments will be apparent to persons skilled in the relevant art(s) based on the following description of FIG. 5B.

Flowchart 510 begins with step 512. In step 512, a list of nodes in the cluster is received from a node in the cluster dynamically appointed as a seed node. For example, as shown in FIGS. 1A-1C and FIG. 2, node C (e.g., upon initialization) may receive a list of nodes in P2P cluster 102 from node D, which is a dynamically appointed seed node.

In step 514, an assignment is received to run a workload that accesses content addressable data from a content addressable store as a process in streaming mode before completing downloading of the content addressable data. For example, as shown in FIGS. 1A-1C and FIG. 2, P2P controller 104 may provide a configuration to nodes A, B, C, and D to run a workload (e.g., container(s) 120) as a process in streaming mode, wherein that workload accesses content addressable data (e.g., container image 140) from a content addressable store (e.g., container registry 108).

In step 516, a node is discovered in the list of nodes that has a range of bytes of the content addressable data in the content addressable store. For example, as shown in FIGS. 1A-1C and FIG. 2, node C may consult its lookup service, which uses the list of nodes in P2P cluster 102 obtained from dynamically appointed seed node D and the data structure DHTC to determine whether and which nodes have file blocks A, B, D, and N needed to continue running the workload (e.g., container(s) 120).

In step 518, the range of bytes of the content addressable data received from the discovered node is provided to the process, allowing the process to run without accessing the content addressable store for content in the range of bytes of the content addressable data. For example, as shown in FIGS. 1A-1C and FIG. 2, node C may provide file blocks A, B, and/or D received from nodes A, B, and D to the workload (e.g., container(s) 120) without accessing the content addressable store (e.g., container registry 108).

### III. Example Computing Device Embodiments

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including being implemented as computer program code (program instructions) configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SOC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 6. FIG. 6 shows a block diagram of an exemplary computing environment 600 that includes a computing device 602. Computing device 602 is an example of node 110 (e.g., nodes A, B, C, and D), P2P controller 104, container registry 108, etc., as shown in FIGS. 1 and 2, which may each include one or more of the components of computing device 602. In some embodiments, computing device 602 is communicatively coupled with devices (not shown in FIG. 6) external to computing environment 600 via network 604. Network 604 comprises one or more networks such as local area networks (LANs), wide area networks (WANs), enterprise networks, the Internet, etc., and may include one or more wired and/or wireless portions. Network 604 may additionally or alternatively include a cellular network for cellular communications. Computing device 602 is described in detail as follows.

Computing device 602 can be any of a variety of types of computing devices. For example, computing device 602 may be a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. Computing device 602 may alternatively be a stationary computing device such as a desktop computer, a personal computer (PC), a stationary server device, a minicomputer, a mainframe, a supercomputer, etc.

As shown in FIG. 6, computing device 602 includes a variety of hardware and software components, including a processor 610, a storage 620, one or more input devices 630, one or more output devices 650, one or more wireless modems 660, one or more wired interfaces 680, a power supply 682, a location information (LI) receiver 684, and an accelerometer 686. Storage 620 includes memory 656, which includes non-removable memory 622 and removable memory 624, and a storage device 690. Storage 620 also stores an operating system 612, application programs 614, and application data 616. Wireless modem(s) 660 include a Wi-Fi modem 662, a Bluetooth modem 664, and a cellular modem 666. Output device(s) 650 includes a speaker 652 and a display 654. Input device(s) 630 includes a touch screen 632, a microphone 634, a camera 636, a physical keyboard 638, and a trackball 640. Not all components of computing device 602 shown in FIG. 6 are present in all embodiments, additional components not shown may be present, and any combination of the components may be present in a particular embodiment. These components of computing device 602 are described as follows.

A single processor 610 (e.g., central processing unit (CPU), microcontroller, a microprocessor, signal processor, ASIC (application specific integrated circuit), and/or other physical hardware processor circuit) or multiple processors 610 may be present in computing device 602 for performing such tasks as program execution, signal coding, data processing, input/output processing, power control, and/or other functions. Processor 610 may be a single-core or multi-core processor, and each processor core may be single-threaded or multithreaded (to provide multiple threads of execution concurrently). Processor 610 is configured to execute program code stored in a computer readable medium, such as program code of operating system 612 and application programs 614 stored in storage 620. The program code is structured to cause processor 610 to perform operations, including the processes/methods disclosed herein. Operating system 612 controls the allocation and usage of the components of computing device 602 and provides support for one or more application programs 614 (also referred to as “applications” or “apps”). Application programs 614 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. Processor(s) 610 may include one or more general processors (e.g., CPUs) configured with or coupled to one or more hardware accelerators, such as one or more NPUs and/or one or more GPUs.

Any component in computing device 602 can communicate with any other component according to function, although not all connections are shown for ease of illustration. For instance, as shown in FIG. 6, bus 606 is a multiple signal line communication medium (e.g., conductive traces in silicon, metal traces along a motherboard, wires, etc.) that may be present to communicatively couple processor 610 to various other components of computing device 602, although in other embodiments, an alternative bus, further buses, and/or one or more individual signal lines may be present to communicatively couple components. Bus 606 represents one or more of any of several types of bus structures, including a memory bus or memory controller, a peripheral bus, an accelerated graphics port, and a processor or local bus using any of a variety of bus architectures.

Storage 620 is physical storage that includes one or both of memory 656 and storage device 690, which store operating system 612, application programs 614, and application data 616 according to any distribution. Non-removable memory 622 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 622 may include main memory and may be separate from or fabricated in a same integrated circuit as processor 610. As shown in FIG. 6, non-removable memory 622 stores firmware 618, which may be present to provide low-level control of hardware. Examples of firmware 618 include BIOS (Basic Input/Output System, such as on personal computers) and boot firmware (e.g., on smart phones). Removable memory 624 may be inserted into a receptacle of or otherwise coupled to computing device 602 and can be removed by a user from computing device 602. Removable memory 624 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 690 may be present that are internal and/or external to a housing of computing device 602 and may or may not be removable. Examples of storage device 690 include a hard disk drive, a SSD, a thumb drive (e.g., a USB (Universal Serial Bus) flash drive), or other physical storage device.

One or more programs may be stored in storage 620. Such programs include operating system 612, one or more application programs 614, and other program modules and program data. Examples of such application programs may include, for example, computer program logic (e.g., computer program code/instructions) for implementing P2P cluster(s) 102, P2P controller 104, container registry 108, node 110 (e.g., nodes A, B, C, and D), as well as any of flowcharts or interaction diagrams 300, 400, 500, 510, and/or any individual steps thereof.

Storage 620 also stores data used and/or generated by operating system 612 and application programs 614 as application data 616. Examples of application data 616 include web pages, text, images, tables, sound files, video data, and other data, which may also be sent to and/or received from one or more network servers or other devices via one or more wired or wireless networks. Storage 620 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 602 through one or more input devices 630 and may receive information from computing device 602 through one or more output devices 650. Input device(s) 630 may include one or more of touch screen 632, microphone 634, camera 636, physical keyboard 638 and/or trackball 640 and output device(s) 650 may include one or more of speaker 652 and display 654. Each of input device(s) 630 and output device(s) 650 may be integral to computing device 602 (e.g., built into a housing of computing device 602) or external to computing device 602 (e.g., communicatively coupled wired or wirelessly to computing device 602 via wired interface(s) 680 and/or wireless modem(s) 660). Further input devices 630 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 654 may display information, as well as operating as touch screen 632 by receiving user commands and/or other information (e.g., by touch, finger gestures, virtual keyboard, etc.) as a user interface. Any number of each type of input device(s) 630 and output device(s) 650 may be present, including multiple microphones 634, multiple cameras 636, multiple speakers 652, and/or multiple displays 654.

One or more wireless modems 660 can be coupled to antenna(s) (not shown) of computing device 602 and can support two-way communications between processor 610 and devices external to computing device 602 through network 604, as would be understood to persons skilled in the relevant art(s). Wireless modem 660 is shown generically and can include a cellular modem 666 for communicating with one or more cellular networks, such as a GSM network for data and voice communications within a single cellular network, between cellular networks, or between the mobile device and a public switched telephone network (PSTN). Wireless modem 660 may also or alternatively include other radio-based modem types, such as a Bluetooth modem 664 (also referred to as a “Bluetooth device”) and/or Wi-Fi modem 662 (also referred to as an “wireless adaptor”). Wi-Fi modem 662 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 664 is configured to communicate with another Bluetooth-capable device according to the Bluetooth short-range wireless technology standard(s) such as IEEE 802.15.1 and/or managed by the Bluetooth Special Interest Group (SIG).

Computing device 602 can further include power supply 682, LI receiver 684, accelerometer 686, and/or one or more wired interfaces 680. Example wired interfaces 680 include a USB port, IEEE 1394 (Fire Wire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 680 of computing device 602 provide for wired connections between computing device 602 and network 604, or between computing device 602 and one or more devices/peripherals when such devices/peripherals are external to computing device 602 (e.g., a pointing device, display 654, speaker 652, camera 636, physical keyboard 638, etc.). Power supply 682 is configured to supply power to each of the components of computing device 602 and may receive power from a battery internal to computing device 602, and/or from a power cord plugged into a power port of computing device 602 (e.g., a USB port, an A/C power port). LI receiver 684 may be used for location determination of computing device 602 and may include a satellite navigation receiver such as a Global Positioning System (GPS) receiver or may include other type of location determiner configured to determine location of computing device 602 based on received information (e.g., using cell tower triangulation, etc.). Accelerometer 686 may be present to determine an orientation of computing device 602.

Note that the illustrated components of computing device 602 are not required or all-inclusive, and fewer or greater numbers of components may be present as would be recognized by one skilled in the art. For example, computing device 602 may also include one or more of a gyroscope, barometer, proximity sensor, ambient light sensor, digital compass, etc. Processor 610 and memory 656 may be co-located in a same semiconductor device package, such as being included together in an integrated circuit chip, FPGA, or system-on-chip (SOC), optionally along with further components of computing device 602.

In embodiments, computing device 602 is configured to implement any of the above-described features of flowcharts herein. Computer program logic for performing any of the operations, steps, and/or functions described herein may be stored in storage 620 and executed by processor 610.

In some embodiments, server infrastructure 670 may be present in computing environment 600 and may be communicatively coupled with computing device 602 via network 604. Server infrastructure 670, when present, may be a network-accessible server set (e.g., a cloud-based environment or platform). As shown in FIG. 6, server infrastructure 670 includes clusters 672. Each of clusters 672 may comprise a group of one or more compute nodes and/or a group of one or more storage nodes. For example, as shown in FIG. 6, cluster 672 includes nodes 674. Each of nodes 674 are accessible via network 604 (e.g., in a “cloud-based” embodiment) to build, deploy, and manage applications and services. Any of nodes 674 may be a storage node that comprises a plurality of physical storage disks, SSDs, and/or other physical storage devices that are accessible via network 604 and are configured to store data associated with the applications and services managed by nodes 674. For example, as shown in FIG. 6, nodes 674 may store application data 678.

Each of nodes 674 may, as a compute node, comprise one or more server computers, server systems, and/or computing devices. For instance, a node 674 may include one or more of the components of computing device 602 disclosed herein. Each of nodes 674 may be configured to execute one or more software applications (or “applications”) and/or services and/or manage hardware resources (e.g., processors, memory, etc.), which may be utilized by users (e.g., customers) of the network-accessible server set. For example, as shown in FIG. 6, nodes 674 may operate application programs 676. In an implementation, a node of nodes 674 may operate or comprise one or more virtual machines, with each virtual machine emulating a system architecture (e.g., an operating system), in an isolated manner, upon which applications such as application programs 676 may be executed.

In an embodiment, one or more of clusters 672 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 672 may be a datacenter in a distributed collection of datacenters. In embodiments, exemplary computing environment 600 comprises part of a cloud-based platform.

In an embodiment, computing device 602 may access application programs 676 for execution in any manner, such as by a client application and/or a browser at computing device 602.

For purposes of network (e.g., cloud) backup and data security, computing device 602 may additionally and/or alternatively synchronize copies of application programs 614 and/or application data 616 to be stored at network-based server infrastructure 670 as application programs 676 and/or application data 678. For instance, operating system 612 and/or application programs 614 may include a file hosting service client configured to synchronize applications and/or data stored in storage 620 at network-based server infrastructure 670.

In some embodiments, on-premises servers 692 may be present in computing environment 600 and may be communicatively coupled with computing device 602 via network 604. On-premises servers 692, when present, are hosted within an organization's infrastructure and, in many cases, physically onsite of a facility of that organization. On-premises servers 692 are controlled, administered, and maintained by IT (Information Technology) personnel of the organization or an IT partner to the organization. Application data 698 may be shared by on-premises servers 692 between computing devices of the organization, including computing device 602 (when part of an organization) through a local network of the organization, and/or through further networks accessible to the organization (including the Internet). Furthermore, on-premises servers 692 may serve applications such as application programs 696 to the computing devices of the organization, including computing device 602. Accordingly, on-premises servers 692 may include storage 694 (which includes one or more physical storage devices such as storage disks and/or SSDs) for storage of application programs 696 and application data 698 and may include one or more processors for execution of application programs 696. Still further, computing device 602 may be configured to synchronize copies of application programs 614 and/or application data 616 for backup storage at on-premises servers 692 as application programs 696 and/or application data 698.

Embodiments described herein may be implemented in one or more of computing device 602, network-based server infrastructure 670, and on-premises servers 692. For example, in some embodiments, computing device 602 may be used to implement systems, clients, or devices, or components/subcomponents thereof, disclosed elsewhere herein. In other embodiments, a combination of computing device 602, network-based server infrastructure 670, and/or on-premises servers 692 may be used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 620. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 614) may be stored in storage 620. Such computer programs may also be received via wired interface(s) 680 and/or wireless modem(s) 660 over network 604. Such computer programs, when executed or loaded by an application, enable computing device 602 to implement features of embodiments discussed herein. Accordingly, such computer programs represent controllers of the computing device 602.

Embodiments are also directed to computer program products comprising computer code or instructions stored on any computer-readable medium or computer-readable storage medium. Such computer program products include the physical storage of storage 620 as well as further physical storage types.

### VI. Additional Example Embodiments

Systems, methods, and instrumentalities are described herein related to container image streaming among peers in a dynamically scalable peer to peer (P2P) cluster. A node receives a list of nodes in the cluster from another node in the cluster dynamically appointed as a seed node, thereby avoiding single points of failure and manual intervention associated with static seed nodes. The node receives an assignment to run a containerized application with a container file system in a container registry as a container process in streaming mode before completing downloading of the container file system. The node discovers a node in the list of nodes that has a range of bytes of a file in the container file system, for example, by receiving an advertisement including a key indicating the byte range or by creating and sending a key indicating the byte range of content in a distributed hash table (DHT). The node provides to the container process the range of bytes of the file received from the discovered node, allowing the container process to run without accessing the container registry for content in the range of bytes of the file.

As described herein by example, block level image content may be distributed to the runtime of containers. Containers may be executed on Kubernetes hosts using DADI. A P2P architecture may utilize a protocol (e.g., Kademlia) to establish a P2P network in a cluster (e.g., Kubernetes cluster) for the transfer of block level image data on demand during container runtime. This approach offers many advantages. For example, cluster operators do not need to maintain root nodes independent of the cluster, the cluster automatically scales to many nodes (e.g., hundreds of thousands of nodes), and the cluster doesn't have any single points of failure, e.g., because the seed nodes are dynamically appointed rather than static. Container performance may be improved for DADI based container runtimes. Further, reliability may be improved, and network errors reduced related to container image pulls may be reduced by enabling cluster nodes to stream image file blocks. Furthermore, the stability of the container registry may be improved, for example, in case of bursty workloads. Even further, the resilience of large cluster deployments may be improved by taking advantage of image content available in a local cluster to create new containers, increasing overall throughput. For example, workloads (e.g., Kubernetes workloads) on clusters with thousands to hundreds of thousands of nodes, such as machine learning (ML) workloads, may run more reliably.

In examples, a computing device may comprise one or more processors and one or more memory devices that store program code configured to be executed by the one or more processors. The computing device may be configured as a node in a cluster of nodes connected in a dynamically scalable peer-to-peer (P2P) network. The node may be configured to receive a list of nodes in the cluster from a node in the cluster dynamically appointed as a seed node. The node may be configured to receive an assignment to run a containerized application with a container file system in a container registry as a container process in streaming mode before completing downloading of the container file system. The node may discover a node in the list of nodes that has a range of bytes of a file in the container file system. The node may provide to the container process the range of bytes of the file received from the discovered node, allowing the container process to run without accessing the container registry for content in the range of bytes of the file.

In examples, the node may be configured to use a distributed data structure to discover the node that has the range of bytes of the file.

In examples, the data structure may comprise a distributed hash table (DHT).

In examples, the node may be (e.g., further) configured to create a key and distribute the key to at least one node in the list of nodes to make a request to stream the content.

In examples, the key may indicate the byte range of the file. The content may be addressable in the DHT using the key.

In examples, discovery of the node in the list of nodes that has the range of bytes of the file in the container file system may comprise receiving an advertisement that the discovered node has the range of bytes of the file.

In examples, the node may be (e.g., further) configured to advertise to nodes in the list of nodes that the node has the range of bytes of the file.

In examples, the node may be (e.g., further) configured to select a node in the list of nodes to connect to for the range of bytes based on a determination that the selected node has the highest probability of storing the range of bytes of the file.

In examples, a method may be implemented in a computing device. The method may comprise, for example, a method in a node in a cluster of nodes connected in a dynamically scalable peer-to-peer (P2P) network may comprise: receiving a list of nodes in the cluster from a node in the cluster dynamically appointed as a seed node; receiving an assignment to run a containerized application with a container file system in a container registry as a container process in streaming mode before completing downloading of the container file system; discovering a node in the list of nodes that has a range of bytes of a file in the container file system; and providing to the container process the range of bytes of the file received from the discovered node, allowing the container process to run without accessing the container registry for content in the range of bytes of the file.

In examples, the node may use a distributed data structure to discover the node that has the range of bytes of the file.

In examples, the data structure may comprise a distributed hash table.

In examples, the discovering of the node in the list of nodes that has the range of bytes of the file in the container file system may comprise receiving an advertisement that the discovered node has the range of bytes of the file.

In examples, the method may (e.g., further) comprise advertising to nodes in the list of nodes that the node has the range of bytes of the file.

In examples, the method may (e.g., further) comprise selecting a node in the list of nodes to connect to for the range of bytes based on a determination that the selected node has the highest probability of storing the range of bytes of the file.

In examples, the method may (e.g., further) comprise creating a key and distributing the key to at least one node in the list of nodes to make a request to stream the content.

In examples, the key may indicate the byte range of the file and wherein the content is addressable in a distributed hash table (DHT) using the key.

In examples, the method may (e.g., further) comprise participating in dynamically appointing the seed node.

In examples, a computer-readable storage medium is described herein. The computer-readable storage medium has program instructions recorded thereon that, when executed by a processor, implements a method comprising: receiving a list of nodes in the cluster from a node in the cluster dynamically appointed as a seed node; receiving an assignment to run a workload that accesses content addressable data from a content addressable store as a process in streaming mode before completing downloading of the content addressable data; discovering a node in the list of nodes that has a range of bytes of the content addressable data in the content addressable store; and providing to the process the range of bytes of the content addressable data received from the discovered node, allowing the process to run without accessing the content addressable store for content in the range of bytes of the content addressable data.

In examples, the method further comprises creating a key indicating the byte range of the content addressable data; and distributing the key to at least one node in the list of nodes to make a request to stream the content.

In examples, the method further comprises advertising to nodes in the list of nodes that the node has content in the range of bytes of the content addressable data.

### VII. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

For example, running examples have been described with respect to malicious activity detectors determining whether compute resource creation operations potentially correspond to malicious activity. However, it is also contemplated herein that malicious activity detectors may be used to determine whether other types of control plane operations potentially correspond to malicious activity.

Several types of impactful operations have been described herein; however, lists of impactful operations may include other operations, such as, but not limited to, accessing enablement operations, creating and/or activating new (or previously-used) user accounts, creating and/or activating new subscriptions, changing attributes of a user or user group, changing multi-factor authentication settings, modifying federation settings, changing data protection (e.g., encryption) settings, elevating another user account's privileges (e.g., via an admin account), retriggering guest invitation e-mails, and/or other operations that impact the cloud-base system, an application associated with the cloud-based system, and/or a user (e.g., a user account) associated with the cloud-based system.

Moreover, according to the described embodiments and techniques, any components of systems, computing devices, servers, device management services, virtual machine provisioners, applications, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A computing device configured as a node in a cluster of nodes connected in a dynamically scalable peer-to-peer (P2P) network, the node configured to:
receive a list of nodes in the cluster from a node in the cluster dynamically appointed as a seed node;
receive an assignment to run a containerized application with a container file system in a container registry as a container process in streaming mode before completing downloading of the container file system;
discover a node in the list of nodes that has a range of bytes of a file in the container file system; and
provide to the container process the range of bytes of the file received from the discovered node, allowing the container process to run without accessing the container registry for content in the range of bytes of the file.

2. The computing device of claim 1, wherein the node uses a distributed data structure to discover the node that has the range of bytes of the file.

3. The computing device of claim 2, wherein the distributed data structure comprises a distributed hash table (DHT).

4. The computing device of claim 3, wherein the node is further configured to:
create a key; and
distribute the key to at least one node in the list of nodes to make a request to stream the content.

5. The computing device of claim 4, wherein the key indicates the byte range of the file and wherein the content is addressable in the DHT using the key.

6. The computing device of claim 1, wherein to discover the node in the list of nodes that has the range of bytes of the file in the container file system, the node is further configured to:
receive an advertisement that the discovered node has the range of bytes of the file.

7. The computing device of claim 1, wherein the node is further configured to:
advertise to nodes in the list of nodes that the node has the range of bytes of the file.

8. The computing device of claim 1, wherein the node is further configured to:
select a node in the list of nodes to connect to for the range of bytes based on a determination that the selected node has the highest probability of storing the range of bytes of the file.

9. A method in a node in a cluster of nodes connected in a dynamically scalable peer-to-peer (P2P) network, the method comprising:
receiving a list of nodes in the cluster from a node in the cluster dynamically appointed as a seed node;
receiving an assignment to run a containerized application with a container file system in a container registry as a container process in streaming mode before completing downloading of the container file system;
discovering a node in the list of nodes that has a range of bytes of a file in the container file system; and
providing to the container process the range of bytes of the file received from the discovered node, allowing the container process to run without accessing the container registry for content in the range of bytes of the file.

10. The method of claim 9, wherein the node uses a distributed data structure to discover the node that has the range of bytes of the file.

11. The method of claim 10, wherein the data structure comprises a distributed hash table.

12. The method of claim 9, wherein the discovering of the node in the list of nodes that has the range of bytes of the file in the container file system comprises:
receiving an advertisement that the discovered node has the range of bytes of the file.

13. The method of claim 9, further comprising:
advertising to nodes in the list of nodes that the node has the range of bytes of the file.

14. The method of claim 9, further comprising:
selecting a node in the list of nodes to connect to for the range of bytes based on a determination that the selected node has the highest probability of storing the range of bytes of the file.

15. The method of claim 9, further comprising:
creating a key; and
distributing the key to at least one node in the list of nodes to make a request to stream the content.

16. The method of claim 15, wherein the key indicates the byte range of the file and wherein the content is addressable in a distributed hash table (DHT) using the key.

17. The method of claim 9, further comprising:
participating in dynamically appointing the seed node.

18. A computer-readable storage medium having program instructions recorded thereon that, when executed by a processor, implements a method comprising:
receiving a list of nodes in the cluster from a node in the cluster dynamically appointed as a seed node;
receiving an assignment to run a workload that accesses content addressable data from a content addressable store as a process in streaming mode before completing downloading of the content addressable data;
discovering a node in the list of nodes that has a range of bytes of the content addressable data in the content addressable store; and
providing to the process the range of bytes of the content addressable data received from the discovered node, allowing the process to run without accessing the content addressable store for content in the range of bytes of the content addressable data.

19. The computer-readable storage medium of claim 18, wherein the method further comprises:
creating a key indicating the byte range of the content addressable data; and
distributing the key to at least one node in the list of nodes to make a request to stream the content.

20. The computer-readable storage medium of claim 19, wherein the method further comprises:
advertising to nodes in the list of nodes that the node has content in the range of bytes of the content addressable data.
